(19) United States
(12) Patent Application Publication
(10) Pub. No.: US 2012/0162062 A1
(43) Pub. Date: Jun. 28, 2012

(54) ELECTRONIC BOOK READING DEVICE WITH AIRFLOW SENSOR

(75) Inventors: ZU-PEI HE, Shenzhen City (CN); XIN ZHAO, Shenzhen City (CN); BIN-GANG DUAN, Shenzhen City (CN); RUEY-SHYANG YOU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/215,231

(22) Filed: Aug. 23, 2011

(30) Foreign Application Priority Data
Dec. 22, 2010 (CN) 201010600675.1

(51) Int. Cl. G09G 5/00

(52) U.S. Cl. 345/156

(57) ABSTRACT

An electronic book reading device includes a housing, an airflow sensor and a controller. The airflow sensor includes a turbine, a shaft fixed to the turbine and a tachometer. The turbine is configured for sensing an airflow and rotating with and about the shaft. The tachometer is connected to the shaft and configured for detecting a rotation speed of the turbine. The controller is configured for determining whether the detected rotation speed of the turbine falls in a predetermined range, and controlling the electronic book reading device to execute a predetermined operation if the detected rotation speed of the turbine falls in the predetermined range.

### BACKGROUND

1. Technical Field

The present disclosure relates to electronic device, especially to an electronic book reading device with airflow sensors.

2. Description of Related Art

Electronic book reading devices generally provide buttons for users to actuate functions of the electronic book reading devices. However, it is not uncommon for buttons to wear over time and become less sensitive and therefore more difficult to operate.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an electronic book reading device according to an exemplary embodiment.

FIG. 2 is a block diagram of the electronic book reading device of FIG. 1.

FIG. 3 is an isometric view of a first airflow sensor in FIG. 1.

### DETAILED DESCRIPTION

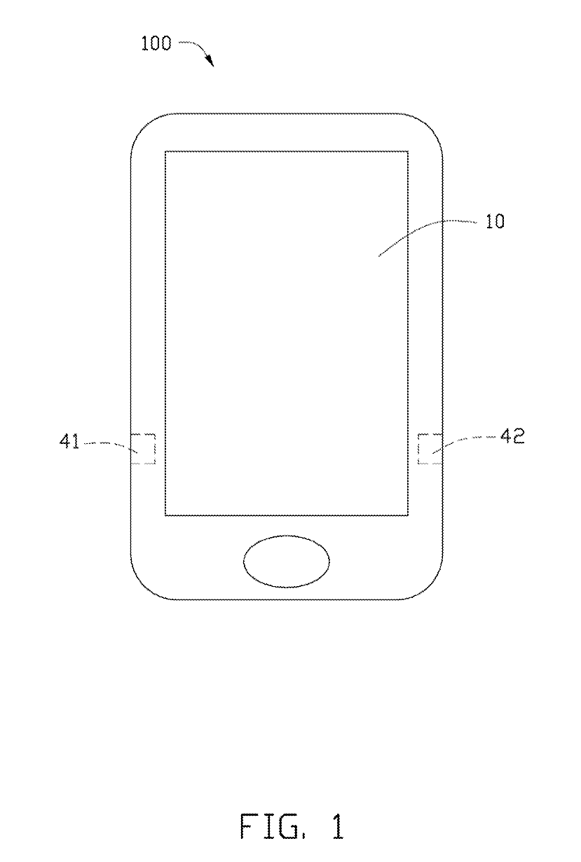

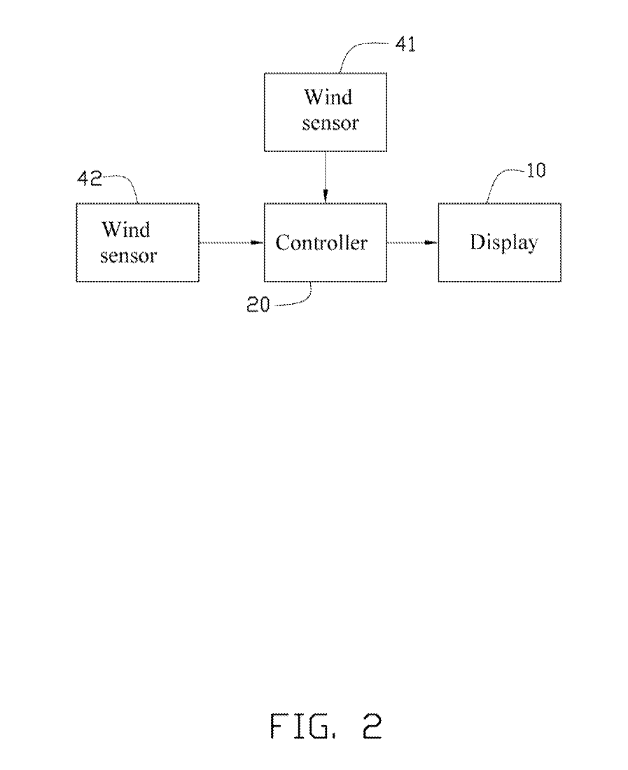

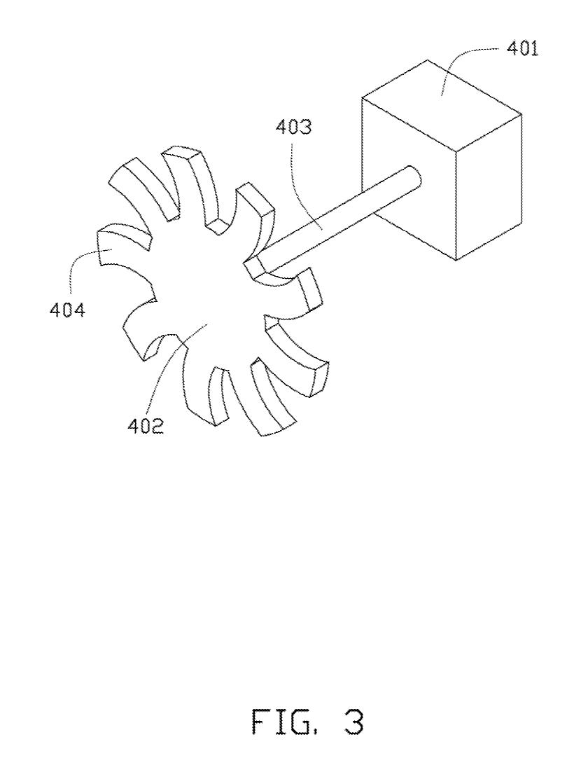

Referring to FIGS. 1, 2 and 3, an electronic book reading device 100 according to an exemplary embodiment includes a housing 10, a controller 20, and two airflow sensors 41, 42.

The airflow sensor 41 includes a tachometer 401, a turbine 402 and a shaft 403. The turbine 402 is fixed to one end of the shaft 403. The tachometer 401 is connected to another end of the shaft 403. The tachometer 401 is fixed in the electronic book reading device 100. The turbine 402 is arranged outside the housing 10. The turbine 402 is configured for sensing an airflow and rotating with and about the shaft 403. A user can provide airflow by, for example, blowing on or waving their hand at the turbine 402. The shaft 403 is rotated by the turbine 402. The tachometer 401 is configured for detecting rotation speed of the shaft 403 and sending it to the controller 20. In the exemplary embodiment, the turbine 402 is substantially a wind vane. The turbine 402 includes a number of radially extending blades 404.

The controller 20 receives the detected rotation speed of the shaft 403. If the rotation speed of the shaft 403 falls in a first predetermined range, the controller 20 controls the electronic book reading device 100 to execute a first predetermined operation, for example, if the electronic book reading device 100 is in a reading mode and an electronic book is opened for users to read, upon determining that the speed of the shaft 403 falls in a first predetermined range, the controller 20 controls the electronic book reading device 100 to flip a page forward.

The airflow sensor 42 is the same as the airflow sensor 41. The controller 20 receives a rotation speed from the airflow sensor 42. If the speed from the airflow sensor 42 falls in a second predetermined range, the controller 20 controls the electronic book reading device 100 to execute a second predetermined operation, such as flipping a page backward.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic book reading device, comprising:
a housing;
an airflow sensor comprising:
a turbine;
a shaft fixed to the turbine, the turbine configured for sensing an airflow and rotating with and about the shaft; and
a tachometer connected to the shaft and configured for detecting a rotation speed of the turbine; and
a controller configured for determining whether the detected rotation speed of the turbine falls in a predetermined range, and controlling the electronic book reading device to execute a predetermined operation if the detected rotation speed of the turbine falls in the predetermined range.

2. The electronic book reading device as described in claim 1, wherein the turbine comprises a plurality of radially extending blades.

3. The electronic book reading device as described in claim 1, wherein the turbine is arranged outside the housing.

4. The electronic book reading device as described in claim 1, wherein the predetermined operation is to flip a page of a currently opened electronic book forward.

5. The electronic book reading device as described in claim 1, wherein the predetermined operation is to flip a page of a currently opened electronic book backward.
